(19) United States
(12) Patent Application Publication
(10) Pub. No.: US 2013/0004815 A1
(43) Pub. Date: Jan. 3, 2013

(54) BATTERY AND MANUFACTURING METHOD THEREOF

(75) Inventor: Koji Kawamoto, Nishikamo-gun (JP)

(73) Assignee: TOYOTA JIDOSHA KABUSHIKI KAISHA, Toyota-shi, Aichi (JP)

(21) Appl. No.: 13/583,076

(22) PCT Filed: Mar. 15, 2010
(86) PCT No.: PCT/JP2010/054332

§ 371 Date: Sep. 13, 2012

(51) Int. Cl. H01M 4/70; H01M 10/04

(52) U.S. Cl. 429/94; 429/211; 29/623.1

(57) ABSTRACT

A battery includes a plurality of power generating elements each including: a cathode layer; an anode layer; an electrolyte layer disposed between the cathode layer and the anode layer; a cathode current collector connected to the cathode layer; and an anode current collector connected to the anode layer, wherein the plurality of power generating elements are wound or folded; and the cathode current collector included in one of the power generating elements and the anode current collector included in another power generating element adjacent to that power generating element are directly or indirectly connected to each other in the entire longitudinal direction of the cathode current collector and the anode current collector before and after the power generating elements are wound or folded.

### TECHNICAL FIELD

The present invention relates to a battery and a manufacturing method thereof. It particularly relates to a battery which comprises two or more current collectors connected to one another, and relates to a manufacturing method thereof.

### BACKGROUND ART

A lithium-ion secondary battery has a characteristic that it has a higher energy density than the other secondary batteries and can be operated at a high voltage. Therefore, it is used for information devices such as a cellular phone as being a secondary battery which can be easily reduced in size and weight. In recent years, there has also been an increasing demand of the lithium-ion secondary battery to be used as a power source for large-scale apparatuses such as electric vehicles and hybrid vehicles.

As a technique related to such a battery, Patent Document 1 for example discloses a battery which comprises a battery element provided with: a cathode having a cathode lead part entirely at one end part of a cathode substrate in the shorter direction thereof; an anode having an anode lead part entirely at one end part of an anode substrate in the shorter direction thereof; and a solid electrolyte layer interposed between the cathode and the anode, wherein the cathode lead part and the anode lead part are electrically connected with the outside in the entire longitudinal direction of each electrode. Patent Document 1 also discloses a configuration in which the battery element is wound or folded in the longitudinal direction of the cathode substrate and the anode substrate; and a configuration in which after the cathode lead part and the anode lead part are layered to be integrated with each other, the cathode lead part provided to one battery element and the anode lead part provided to the other battery element are directly connected with each other. In addition, Patent Document 2 discloses a manufacturing method of a secondary battery comprising: a first forming step for forming a cell comprising a flat sheet-shaped cathode and a flat sheet-shaped anode layered on top of each other with a separator disposed therebetween; and a second forming step for forming another cell comprising electrodes layered such that an edge portion of the electrode, which has a polarity different from the polarity of an edge portion of the electrode in the cell formed by the first forming step, is overlapped with the edge portion of the electrode in the cell formed by the first forming step.

### CITATION LIST

### Patent Literatures

Patent Document 1: Japanese Patent Application Laid-Open (JP-A) No. 2003-187781
Patent Document 2: JP-A No. 2004-247153

### SUMMARY OF THE INVENTION

### Problems to be Solved by the Invention

In the technique disclosed in Patent Document 1, the cathode-exposed part and the anode-exposed part in the battery element are arranged in the entire shorter direction of the cathode substrate and the anode substrate. Therefore, it is seen to be possible to reduce an electrical resistance. In addition, in the technique disclosed in Patent Document 2, the edge portion of the cathode and the edge portion of the anode are connected at a connecting portion of the cell. Therefore, no components to connect a plurality of cells are necessary and it is seen to be possible to reduce the electrical resistance at the connecting portion of the cell. However, in these techniques, when connecting current collectors of the adjacent cells (power generating elements), only one part of each of the current collectors in the longitudinal direction thereof is contacted with each other (in a case when the current collectors are wound or folded, only a portion corresponding to one part of the current collectors in the longitudinal direction before wound or folded is contacted); thereby the current collectors are connected. Therefore, as disclosed in Patent Document 1 for example, when connecting current collectors with one another, it is necessary to collect a plurality of the current collectors in one location. The current collectors tend to be damaged and broken when collected in one location to be integrated. Therefore, with the techniques disclosed in Patent Documents 1 and 2, the effect of reducing the electrical resistance tends to degrade.

Accordingly, an object of the present invention is to provide a battery in which the electrical resistance between power generating elements can be reduced, and a manufacturing method thereof.

### Means for Solving the Problems

In order to solve the above problems, the present invention takes the following means.

A first aspect of the present invention is a battery comprising a plurality of power generating elements each comprising: a cathode layer; an anode layer; an electrolyte layer disposed between the cathode layer and the anode layer; a cathode current collector connected to the cathode layer; and an anode current collector connected to the anode layer, wherein the plurality of power generating elements are wound or folded; and the cathode current collector included in one of the power generating elements and the anode current collector included in another power generating element adjacent to that power generating element are directly or indirectly connected to each other in the entire longitudinal direction of the cathode current collector and the anode current collector before and after the power generating elements are wound or folded.

In the above first aspect of the present invention, the cathode current collector which is bent and the anode current collector which is bent may be fitted with each other, and thereby the cathode current collector and the anode current collector may be connected to each other.

In the above first aspect of the present invention, in which the cathode current collector which is bent and the anode current collector which is bent are fitted with each other and thereby the cathode current collector and the anode current collector are connected to each other, the cathode current collector and the anode current collector that are connected to each other are preferably fixated by a fixating member.

In the above first aspect of the present invention, the cathode current collector and the anode current collector may be connected via a conductor which is in contact with the cathode current collector and the anode current collector.

Additionally, in the above first aspect of the present invention, in which the cathode current collector and the anode current collector are connected via a conductor, the cathode current collector which is bent and the conductor which is bent may be fitted with each other, and the conductor which is bent and the anode current collector which is bent may be fitted with each other.

A second aspect of the present invention is a manufacturing method of a battery comprising: a power generating element production step of producing a plurality of power generating elements each comprising a cathode layer, an anode layer, an electrolyte layer disposed between the cathode layer and the anode layer, a cathode current collector connected to the cathode layer, and an anode current collector connected to the anode layer; a connection step of connecting directly or indirectly the cathode current collector included in one of the power generating elements produced in the power generating element production step and the anode current collector included in another power generating element produced in the power generating element production step, in the entire longitudinal direction of the cathode current collector and the anode current collector; and a winding/folding step of winding or folding the plurality of power generating elements after the connection step.

In the above second aspect of the present invention, the connection step may be a step of fitting the cathode current collector which is bent with the anode current collector which is bent, and thereby connecting the cathode current collector and the anode current collector to each other.

The above second aspect of the present invention, which comprises the connection step of fitting the cathode current collector which is bent with the anode current collector which is bent and thereby connecting the cathode current collector and the anode current collector to each other, preferably further comprises, after the winding/folding step, a fixation step of fixating the cathode current collector and the anode current collector connected to each other by using a fixating member.

In the second aspect of the present invention, the “cathode current collector which is bent” and the “anode current collector which is bent” may be a cathode current collector and an anode current collector which are bent in the connection step; or they may be a cathode current collector and an anode current collector which have been bent in advance prior to the connection step.

In the above second aspect of the present invention, the connection step may be a step of connecting the cathode current collector and the anode current collector via a conductor which is in contact with the cathode current collector and the anode current collector.

Additionally, in the above second aspect of the present invention, which comprises the connection step in a configuration of connecting the cathode current collector and the anode current collector via the conductor, the connection step may be a step of fitting the cathode current collector which is bent with the conductor which is bent, also fitting the conductor which is bent with the anode current collector which is bent, and thereby connecting the cathode current collector and the anode current collector.

In the second aspect of the present invention, the “conductor which is bent” may be a conductor which is bent in the connection step; or it may be a conductor which has been bent in advance prior to the connection step.

### Effects of the Invention

In the first aspect of the present invention, the cathode current collector included in one of the power generating elements and the anode current collector included in another power generating element adjacent to that power generating element are connected with each other in the entire longitudinal direction of the cathode current collector and the anode current collector before and after the power generating elements are wound or folded. With this configuration, it is possible to provide a battery that does not necessitate integration of the current collectors, which is required in the conventional batteries, and therefore it is possible to prevent the damage and the breakage of the current collectors caused at the time when they are integrated. Further, with this configuration even in the case of integrating the current collectors as in the conventional batteries, the damage and the breakage of the current collectors can be inhibited. Therefore, according to the first aspect of the present invention, it is possible to provide a battery in which the electrical resistance between the power generating elements can be reduced.

In the first aspect of the present invention, the cathode current collector which is bent and the anode current collector which is bent are fitted with each other, and thereby the cathode current collector and the anode current collector are connected with each other. Thereby, the thickness of the connection portion to connect the cathode current collector and the anode current collector can be made larger than in the conventional cases. Accordingly, with this configuration even in the case of integrating the current collectors, the damage and the breakage of the current collectors can be inhibited.

In the above first aspect of the present invention, in which the cathode current collector which is bent and the anode current collector which is bent are fitted with each other and thereby the cathode current collector and the anode current collector are connected with each other, the cathode current collector and the anode current collector that are connected with each other are fixated by the fixating member. Thereby, the electrical resistance between the power generating elements can be easily reduced.

In the first aspect of the present invention, the cathode current collector and the anode current collector are connected via the conductor which is in contact with the cathode current collector and the anode current collector. Thereby, it is unnecessary to integrate the current collectors after winding or folding the power generating elements. Therefore, with this configuration it is possible to prevent the damage and the breakage of the current collectors caused at the time when they are integrated.

In the first aspect of the present invention, in which the cathode current collector and the anode current collector are connected via the conductor, even by fitting together the cathode current collector, the conductor, and the anode current collector, which are bent, it is unnecessary to integrate the current collectors after winding or folding the power generating elements. Accordingly, with this configuration as well it is possible to prevent the damage and the breakage of the current collectors caused at the time when they are integrated.

In the second aspect of the present invention, the cathode current collector included in one of the power generating elements and the anode current collector included in another power generating element adjacent to that power generating element are connected with each other in the entire longitudinal direction of the cathode current collector and the anode current collector; and thereafter the power generating elements are wound or folded. Accordingly, in the second aspect of the present invention, the battery according to the first aspect can be manufactured. Therefore, according to the second aspect of the present invention, it is possible to provide a manufacturing method of a battery which enables manufacturing of the battery in which the electrical resistance between the power generating elements can be reduced.

In the second aspect of the present invention, the cathode current collector which is bent and the anode current collector which is bent are fitted with each other, and thereby the cathode current collector and the anode current collector are connected with each other. Thereby, the thickness of the connection portion to connect the cathode current collector and the anode current collector can be made larger than in the conventional cases. Therefore, with this configuration even in the case of integrating the current collectors after winding or folding the power generating elements, the damage and the breakage of the current collectors can be inhibited.

In the above second aspect of the present invention, which comprises the connection step of fitting the cathode current collector which is bent with the anode current collector which is bent and thereby connecting the cathode current collector and the anode current collector with each other, the fixation step is further provided. Thereby, the electrical resistance between the power generating elements can be easily reduced.

In the second aspect of the present invention, the cathode current collector and the anode current collector are connected via the conductor which is in contact with the cathode current collector and the anode current collector. Thereby, it is unnecessary to integrate the current collectors after winding or folding the power generating elements. Therefore, with this configuration it is possible to prevent the damage and the breakage of the current collectors caused at the time when they are integrated.

In the second aspect of the present invention, in which the cathode current collector and the anode current collector are connected via the conductor, even by fitting together the cathode current collector, the conductor, and the anode current collector, which are bent, and thereby connecting the cathode current collector and the anode current collector, it is unnecessary to integrate the current collectors after winding or folding the power generating elements. Therefore, with this configuration as well it is possible to prevent the damage and the breakage of the current collectors caused at the time when they are integrated.

### BRIEF DESCRIPTION OF THE DRAWINGS

FIG. 1 is a cross sectional view illustrating a structure 7.

FIG. 2 is a view illustrating a wound body 9.

FIG. 3 is a view illustrating a conventional battery comprising integrated current collectors.

FIG. 4 is a flowchart illustrating a manufacturing method of a battery 10.

FIG. 5 is a cross sectional view illustrating a structure 26.

FIG. 6 is a view illustrating a wound body 27.

FIG. 7 is a flowchart illustrating a manufacturing method of a battery 20.

FIG. 8 is a cross sectional view illustrating a structure 36.

FIG. 9 is a view illustrating a wound body 37.

FIG. 10 is a flowchart illustrating a manufacturing method of a battery 30.

### DESCRIPTION OF THE REFERENCE NUMERALS

1 cathode layer
2 anode layer
3 electrolyte layer
4 cathode current collector
5 anode current collector
6 power generating element
7 structure
8 connection portion
9 wound body
10 battery
11 fixating member
20 battery
21 cathode current collector
22 anode current collector
23 power generating element
24 conductor
25 connection portion
26 structure
27 wound body
30 battery
31 cathode current collector
32 anode current collector
33 power generating element
34 conductor
35 connection portion
36 structure
37 wound body
91 cathode current collector
92 anode current collector
93 power generating element
94 connecting terminal
95 structure

### MODES FOR CARRYING OUT THE INVENTION

Hereinafter, the present invention will be described with reference to the drawings. It should be noted that the embodiments shown below are examples of the present invention and that the present invention is not limited to these embodiments.

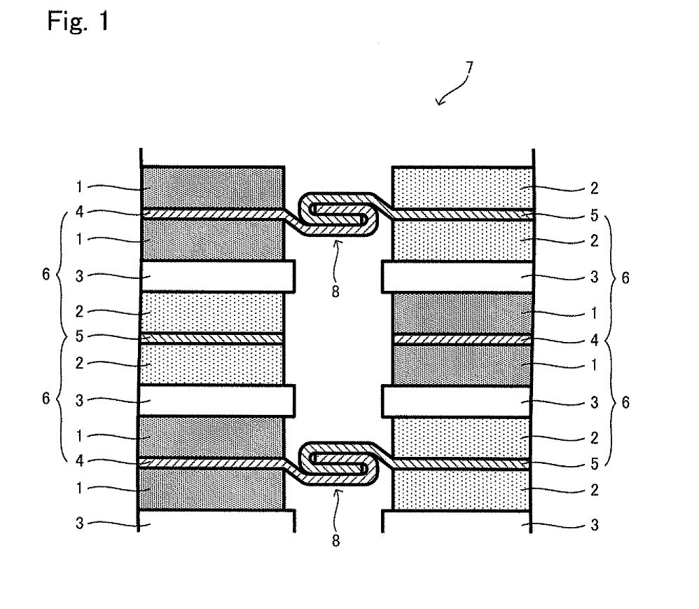

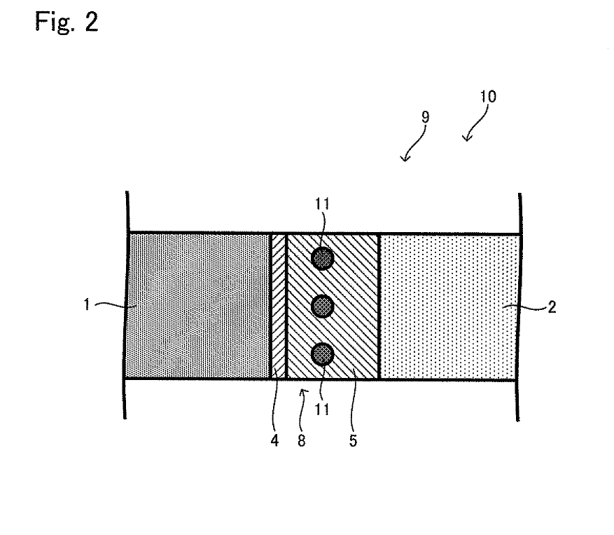

FIGS. 1 and 2 are views illustrating a battery 10 of the present invention according to one embodiment. FIG. 1 shows a cross section of a structure 7 comprising power generating elements 6, 6, . . . before being wound. It only shows the connection parts of two sets of cathode current collector 4, 4, and anode current collector 5, 5, and the surrounding area thereof. The left and right direction of the drawing sheet of FIG. 1 is the shorter direction of the cathode current collector 4 and the anode current collector 5. The back and front direction of the drawing sheet of FIG. 1 is the longitudinal direction of the cathode current collector 4 and the anode current collector 5. In addition, FIG. 2 is a front view illustrating a wound body 9 formed after winding the power generating elements 6, 6, . . . . It shows only a part where a set of fixating members 11, 11, . . . is disposed, and the surrounding area thereof. The left and right direction of the drawing sheet of FIG. 2 is the shorter direction of the cathode current collector 4 and the anode current collector 5.

As shown in FIGS. 1 and 2, the structure 7 and the wound body 9 comprise a plurality of power generating elements 6, 6, . . . each provided with: a cathode layer 1; an anode layer 2; an electrolyte layer 3 disposed between the cathode layer 1 and the anode layer 2; a cathode current collector 4 connected to the cathode layer 1; and an anode current collector 5 connected to the anode 2. The cathode layer 1, 1 is disposed on front and back faces of the cathode current collector 4. The anode layer 2, 2 is disposed on front and back faces of the anode current collector 5. The electrolyte layer 3 is disposed between a pair of the cathode layer 1 and the anode layer 2. In the structure 7 and the wound body 9, one end of the cathode current collectors 4, 4, . . . in the shorter direction thereof and one end of the anode current collectors 5, 5, . . . in the shorter direction thereof are bent. The bent end portion of the cathode current collector 4 in the shorter direction thereof and the bent end portion of the anode current collector 5 in the shorter direction thereof are fitted with each other in the entire longitudinal direction of the cathode current collector 4 and the anode current collector 5. Thereby, a connection portion is formed which has the cathode current collector 4 and the anode current collector 5 connected with each other in the entire longitudinal direction. The structure 7 comprising a plurality of the connection portions 8, 8, . . . is wound in the back and front direction of the drawing sheet of FIG. 1. Then, the plurality of connection portions 8, 8, . . . provided in the back and front direction in FIG. 2 are integrated and fixated by fixating members 11, 11, . . . , thereby forming a wound body 9. The wound body 9 is for example accommodated into an exterior material not shown; and thereby the battery 10 of the present invention is produced.

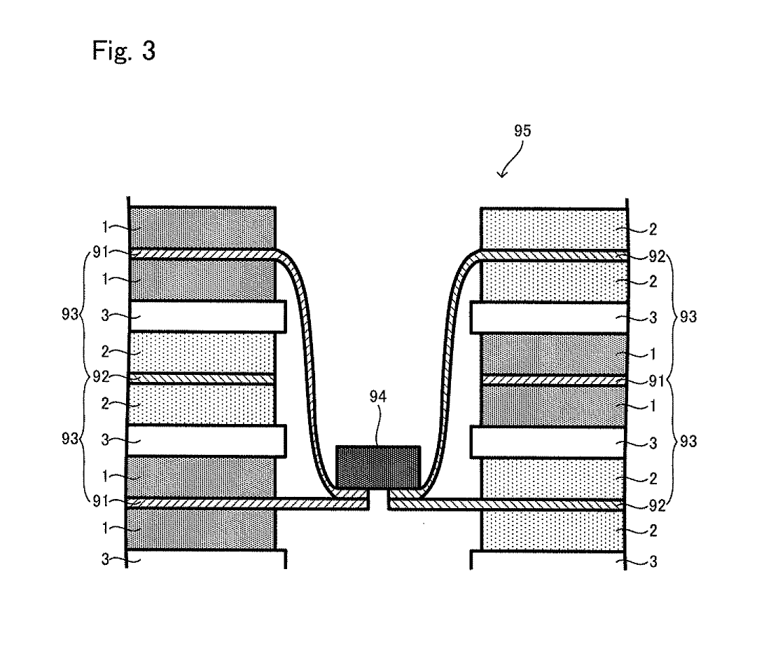

FIG. 3 is a cross sectional view illustrating a configuration of a battery according to a reference example. FIG. 3 shows a structure 95 comprising power generating elements 93, 93, . . . before being wound. It only shows cathode current collectors 91, 91 and anode current collectors 92, 92 that are integrated by means of a connecting terminal 94, and the surrounding area thereof. The left and right direction of the drawing sheet of FIG. 3 is the shorter direction of the cathode current collector 91 and the anode current collector 92. The back and front direction of the drawing sheet of FIG. 3 is the longitudinal direction of the cathode current collector 91 and the anode current collector 92. The conventional battery is produced by accommodating a wound body into an exterior material or the like not shown, the wound body being formed by winding the structure 95 in the back and front direction of the drawing sheet of FIG. 3. In FIG. 3, the same constituents as those of the battery 10 are given the same reference numerals used in FIGS. 1 and 2; and descriptions thereof will be omitted.

As shown in FIG. 3, the structure 95 comprise a plurality of power generating elements 93, 93, . . . each provided with: a cathode layer 1; an anode layer 2; an electrolyte layer 3 disposed between the cathode layer 1 and the anode layer 2; a cathode current collector 91 connected to the cathode layer 1; and an anode current collector 92 connected to the anode layer 2. The cathode layer 1, 1 is disposed on front and back faces of the cathode current collector 91. The anode layer 2, 2 is disposed on front and back faces of the anode current collector 92. The electrolyte layer 3 is disposed between a pair of the cathode layer 1 and the anode layer 2. Unlike the battery 10, neither of the both ends of the cathode current collector 91 and the anode current collector 92 in the shorter direction thereof is bent. In the structure 95, a plurality of the cathode current collectors 91, 91, . . . and a plurality of the anode current collectors 92, 92, . . . to be connected to each other are collected in one location; and thereafter they are fixated by the connecting terminal 94. Thereby, the plurality of cathode current collectors 91, 91, . . . and the plurality of anode current collectors 92, 92, . . . are integrated. As shown in FIG. 3, in the conventional battery, the thickness of the cathode current collectors 91, 91, and of the anode current collectors 92, 92, . . . differs from the thickness of the power generating elements 93, 93, . . . to a large degree. Therefore, the cathode current collectors 91, 91, . . . and the anode current collectors 92, 92, . . . that are disposed in a position far from the area where they are integrated by means of the connecting terminal 94 (for example, the cathode current collector 91 and the anode current collector 92 that are disposed on the upper side of the drawing sheet of FIG. 3), are pulled strongly when collected in one location, and therefore easily damaged and broken. If the cathode current collector 91 and the anode current collector 92 are damaged and broken, the electrical resistance easily increases between the power generating elements 93, 93 that are electrically connected through the cathode current collector 91 and the anode current collector 92. Therefore, the conventional battery has a problem that the electrical resistance therein is difficult to reduce.

By contrast, the battery 10 comprises the cathode current collectors 4, 4, . . . and the anode current collectors 5, 5, . . . , one end of which in the shorter direction thereof is respectively bent. With the configuration comprising such cathode current collectors 4, 4, . . . and the anode current collectors 5, 5, . . . , the difference between the thickness of the connection portions 8, 8, . . . and the thickness of the power generating elements 6, 6, . . . (hereinafter referred to as a “thickness difference”) can be made smaller than the difference between the thickness of the cathode current collector 91 and of the anode current collector 92 and the thickness of the power generating element 93 (hereinafter referred to as a “difference in the reference example”). More specifically, when the cathode current collector 4 and the anode current collector 5 have the same thickness for example, the thickness of the connection portions 8, 8, . . . becomes four times larger than the thickness of the cathode current collector 4 and the thickness of the anode current collector 5. Therefore, according to the battery 10, the thickness difference can be made smaller than the difference in the reference example. By reducing the thickness difference in this manner, when collecting the plurality of connection portions 8, 8, . . . in one location, it is possible to reduce the tension applied to the cathode current collectors 4, 4, . . . and the anode current collectors 5, 5, . . . that are disposed in a position far from the one location where they are collected. Therefore, the damage and the breakage of the cathode current collectors 4, 4, . . . and the anode current collectors 5, 5, . . . can be inhibited. By inhibiting the cathode current collectors 4, 4, . . . and the anode current collectors 5, 5, . . . from being damaged and broken, it is possible to reduce the electrical resistance between the power generating elements 6, 6, . . . that are electrically connected via the connection portions 8, 8, . . . . Therefore, according to the present invention, it is possible to provide the battery 10 in which the electrical resistance can be reduced.

Further, in the battery 10, the plurality of connection portions 8, 8, . . . are integrated and fixated by means of the fixating device 11, 11, . . . . With this configuration, the cathode current collectors 4, 4, . . . and the anode current collectors 5, 5, . . . can be easily bonded strongly. Therefore, the effect of reducing the electrical resistance can be enhanced.

In the present invention, the cathode layer 1, 1, disposed on the front and back faces of the cathode current collector 4 can be made for example by: mixing a cathode material and a solid electrolyte (e.g. a sulfide solid electrolyte such as Li₃PS₄; an oxide solid electrolyte such as Li₃PO₄; or a polymer electrolyte such as polyethylene oxide (PEO)) to make a mixture; applying the mixture onto the front and back faces of the cathode current collector 4; and thereafter pressing it at a pressure of 100 MPa at room temperature for 10 seconds. Examples of the cathode material to be contained in the cathode layer 1 may be a lithium transition metal oxide and a chalcogenide. Examples of the lithium transition metal oxide to be contained in the cathode layer 1 include: lithium cobalt oxide (LiCoO₂); lithium nickel oxide (LiNiO₂); lithium manganese oxide (LiMnO₂); iron olivine (LiFePO₄); cobalt olivine (LiCoPO₄); manganese olivine (LiMnPO₄); and lithium titanate (Li₄Ti₅O₁₂). In addition, examples of the chalcogenide to be contained in the cathode layer 1 include: copper chevrel (Cu₂Mo₆S₈), iron sulfide (FeS); cobalt sulfide (CoS); and nickel sulfide (NiS). In the present invention, the thickness of the cathode layer 1 may be for example 50 μm.

In the present invention, the anode layer 2, 2, disposed on the front and back faces of the anode current collector 5 can be made for example by: mixing an anode material and a solid electrolyte (e.g. a sulfide solid electrolyte such as Li₃PS₄; an oxide solid electrolyte such as Li₃PO₄; or a polymer electrolyte such as polyethylene oxide (PEO)) to make a mixture; applying the mixture onto the front and back faces of the anode current collector 5; and thereafter pressing it at a pressure of 100 MPa at room temperature for 10 seconds. Examples of the anode material to be contained in the anode layer 2 may be a carbon, a lithium transition metal oxide, and an alloy. An example of the lithium transition metal oxide to be contained in the anode layer 2 may be lithium titanate (Li₄Ti₅O₁₂). In addition, an example of the alloy to be contained in the anode layer 2 may be La₃Ni₂Sn₇. In the present invention, the thickness of the anode layer 2 may be for example 60 μm.

In the present invention, the configuration of the electrolyte layer 3 disposed between a pair of the cathode layer 1 and the anode layer 2 is not particularly limited. The electrolyte layer 3 may be for example a solid electrolyte layer containing a known solid electrolyte; it may also be an electrolyte layer containing a known gelatinous electrolyte. In the case when the electrolyte layer 3 is a solid electrolyte layer, it can be made by pressing a sulfide solid electrolyte such as Li₃PS₄ at a pressure of 100 MPa for 10 seconds. In the present invention, the thickness of the electrolyte layer 3 may be for example 20 μm.

Further, in the present invention, the cathode current collector 4 may be preferably constituted by a conductive material that can endure the environment under which the battery 10 is used. For example, it may be constituted by an aluminum foil having a thickness of several micrometers to several ten micrometers. Additionally, in the present invention, the anode current collector 5 may be preferably constituted by a conductive material that can endure the environment under which the battery 10 is used, and may be constituted by a copper foil having a thickness of several micrometers to several ten micrometers.

Also in the present invention, the configuration of the fixating member 11 is not particularly limited as long as it can endure the environment under which the battery 10 is used and can integrate and fixate the plurality of connection portions 8, 8, . . . . A known rivet or the like may be adequately used as the fixating member 11. So far, the battery 10 comprising the fixating members 11, 11, . . . has been described, but the battery of the present invention comprising the plurality of connection portions 8, 8, . . . is not limited to the configuration that the fixating member is provided. However, in order to provide a battery configured such that the cathode current collector 4 and the anode current collector 5 connected to each other in the entire longitudinal direction thereof are bonded more strongly, and thereby the electrical resistance is easily reduced, it is preferable for the battery to be provided with the fixating member which integrates and fixates a plurality of connection portions.

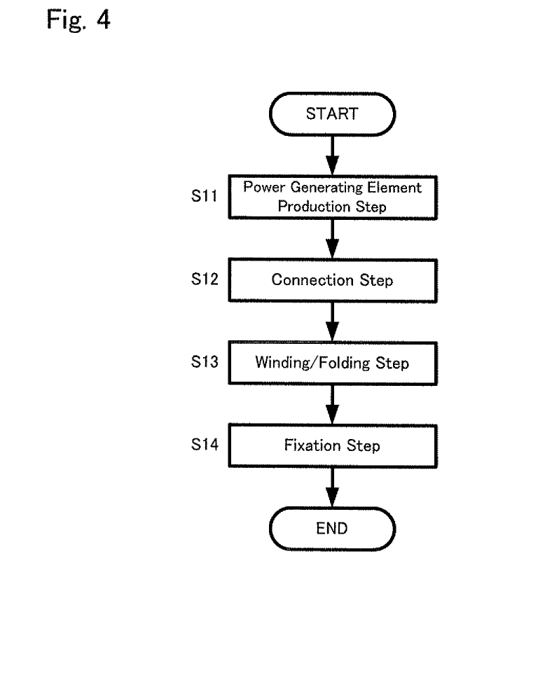

FIG. 4 is a flow chart illustrating a manufacturing process of the battery 10. Hereinafter, a manufacturing method of the battery 10 (one configuration of a manufacturing method of a battery according to the present invention) will be described with reference to FIGS. 1, 2, and 4. As shown in FIG. 4, the battery 10 is manufactured through a power generating element production step (S11), a connection step (S12), a winding/folding step (S13), and a fixation step (S14).

The power generating element production step (hereinafter referred to as “S11”) is a step of producing the power generating elements 6, 6, . . . . In the manufacturing method of the battery 10, the configuration of S11 is not particularly limited as long as S11 can produce the power generating elements 6, 6, . . . . In S11, for example a cathode material and a solid electrolyte are mixed to form a mixture; the mixture is applied onto the front and back faces of the cathode current collector 4, one end of which in the shorter direction is bent; and thereafter it is pressed at a pressure of 100 MPa at room temperature for 10 seconds. Thereby, a cathode structure can be produced in which the cathode layer 1, 1 having a thickness of 50 μm is disposed on each of the front and back faces of the cathode current collector 4. Further, for example an anode material and a solid electrolyte are mixed to form a mixture; the mixture is applied onto the front and back faces of the anode current collector 5, one end of which in the shorter direction is bent; and thereafter it is pressed at a pressure of 100 MPa at room temperature for 10 seconds. Thereby, an anode structure can be produced in which the anode layer 2, 2 having a thickness of 60 μm is disposed on each of the front and back faces of the anode current collector 5. Furthermore, for example by pressing a sulfide solid electrolyte such as Li₃PS₄ at a pressure of 100 MPa for 10 seconds, the electrolyte layer 3 having a thickness of 20 μm can be produced. After making the cathode structure, the anode structure, and the electrolyte layer 3 in this manner, the cathode structure, the electrolyte layer 3, and the anode structure are layered such that the electrolyte layer 3 is disposed between a pair of the cathode layer 1 and the anode layer 2. Thereby, the power generating element 6 can be produced. By repeating the above process, a plurality of power generating elements 6, 6, . . . can be produced.

The connection step (hereinafter referred to as “S12”) is a step of connecting the cathode current collector 4 included in the power generating element 6 produced in S11 above with the anode current collector 5 included in the power generating element 6 adjacent thereto in the left and right direction of the drawing sheet of FIG. 1, in the entire longitudinal direction of the cathode current collector 4 and the anode current collector 5; thereby forming the connection portion 8; and through this process, forming the structure 7 shown in FIG. 1. The configuration of S12 is not particularly limited as long as S12 can produce the structure 7 comprising a plurality of the connection portions 8, 8, . . . . For example, in S12, one end of the cathode current collector 4 in its shorter direction, the end being bent over its entire longitudinal direction, is fitted with one end of the anode current collector 5 in its shorter direction, the end being bent over its entire longitudinal direction. Thereby, the connection portion 8 can be formed.

The winding/folding step (hereinafter referred to as “S13”) is a step of winding the structure 7 produced in S12 above in the longitudinal direction of the cathode current collector 4 and the anode current collector 5, and thereby producing a wound body.

The fixation step (hereinafter referred to as “S14”) is a step of integrating the plurality of connection portions 8, 8, . . . provided to the wound body produced in S13 above, by using the fixating members 11, 11, . . . , and thereby producing the wound body 9 comprising the plurality of connection portions 8, 8, . . . that are fixated. The configuration of S14 is not particularly limited as long as S14 can produce the wound body 9. S14 may be for example a step of forming holes that penetrate through the plurality of connection portions 8, 8, . . . that are to be integrated; thereafter inserting the fixating members 11, 11, . . . into the holes; deforming the top end of the fixating members 11, 11, . . . inserted; and thereby producing the wound body 9.

Through the steps S11 to S14 as above, the wound body 9 can be produced. Then, the battery 10 can be manufactured through the process of for example accommodating the wound body 9 into an exterior material and sealing the exterior material in which the wound body 9 is accommodated. Therefore, according to the present invention, it is possible to provide a manufacturing method of a battery which enables manufacturing of the battery 10 in which the electrical resistance between the power generating elements 6, 6 can be reduced.

In the above descriptions of the battery 10 and the manufacturing method of the battery 10 of the present invention, the configuration has been shown which comprises the connection portions 8, 8, . . . formed by directly connecting the cathode current collectors 4, 4, . . . with the anode current collectors 5, 5, . . . . However, the present invention is not limited to this configuration. Accordingly, the present invention according to another embodiment will be described below.

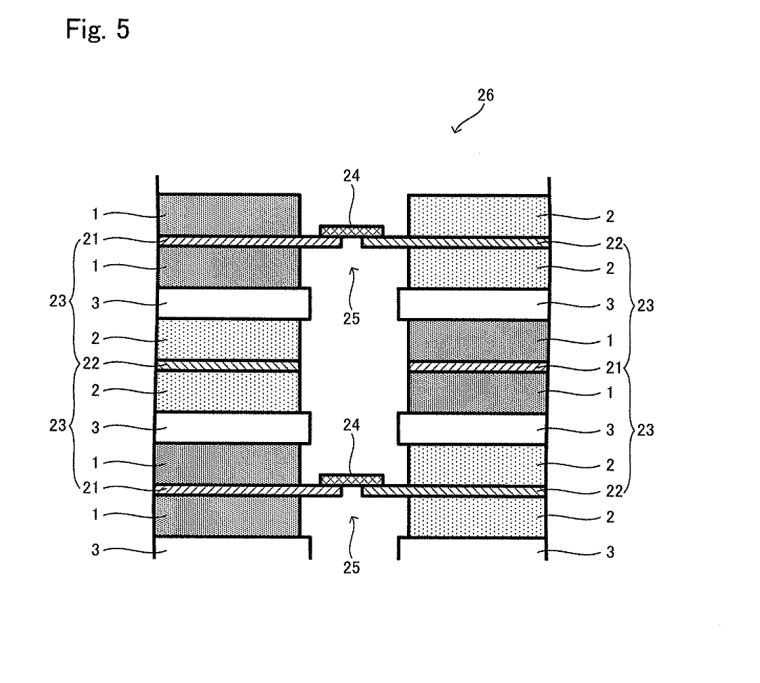

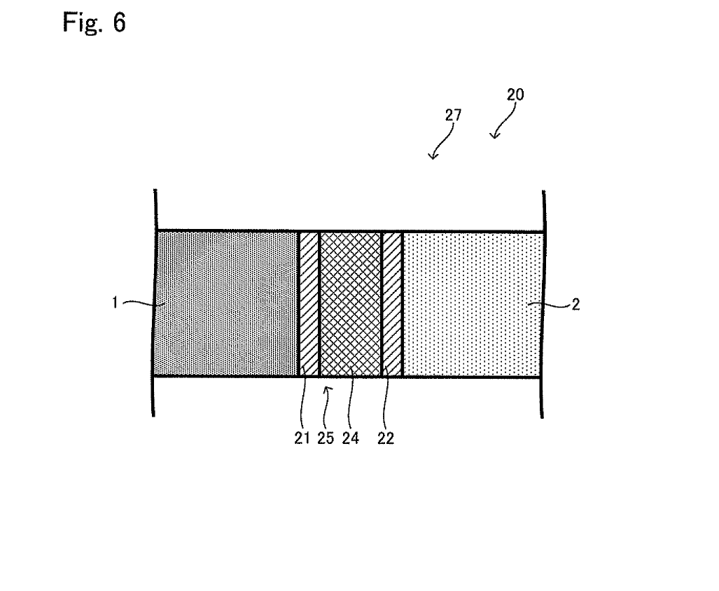

FIGS. 5 and 6 are views illustrating a battery 20 of the present invention according to a second embodiment. FIG. 5 corresponds to FIG. 1. FIG. 5 shows a cross section of a structure 26 comprising power generating elements 23, 23, . . . before wound. It only shows the connection parts of two sets of cathode current collector 21, 21 and anode current collector 22, 22, and the surrounding area thereof. The left and right direction of the drawing sheet of FIG. 5 is the shorter direction of the cathode current collector 21 and the anode current collector 22. The back and front direction of the drawing sheet of FIG. 5 is the longitudinal direction of the cathode current collector 21 and the anode current collector 22. In addition, FIG. 6 is a front view illustrating a wound body 27 formed after winding the power generating elements 23, 23, . . . . It shows only a connection portion 25 and the surrounding area thereof. The left and right direction of the drawing sheet of FIG. 6 is the shorter direction of the cathode current collector 21 and the anode current collector 22. In FIGS. 5 and 6, the same constituents as those of the battery 10 are given the same reference numerals given in FIGS. 1 and 2; and descriptions thereof will be omitted.

As shown in FIGS. 5 and 6, the structure 26 and the wound body 27 comprise a plurality of power generating elements 23, 23, . . . each provided with: a cathode layer 1; an anode layer 2; an electrolyte layer 3 disposed between the cathode layer 1 and the anode layer 2; a cathode current collector 21 connected to the cathode layer 1; and an anode current collector 22 connected to the anode layer 2. The cathode layer 1, 1 is disposed on front and back faces of the cathode current collector 21. The anode layer 2, 2 is disposed on front and back faces of the anode current collector 22. The electrolyte layer 3 is disposed between a pair of the cathode layer 1 and the anode layer 2. In the structure 26, neither of the both ends of the cathode current collectors 21, 21, . . . and of the anode current collectors 22, 22, . . . in the shorter direction thereof is bent. In the structure 26, a conductor 24 is in contact with the entire length of one end of the cathode current collector 21 in the shorter direction thereof and with the entire length of one end of the anode current collector 22 in the shorter direction thereof. The conductor 24 and the cathode current collector 21 are joined, and the conductor 24 and the anode current collector 22 are joined, thereby forming the connection portion 25. The structure 26 comprising a plurality of the connection portions 25, 25, . . . is wound in the back and front direction of the drawing sheet of FIG. 5, and thereby is formed into the wound body 27. Then, the battery 20 of the present invention can be produced for example by accommodating this wound body 27 into an exterior material.

In the battery 20, the cathode current collector 21 and the anode current collector 22 have been integrated via the conductor 24 in the stage of the structure 26. Therefore, it is unnecessary to integrate the cathode current collectors 21, 21, . . . and the anode current collectors 22, 22, . . . after forming the wound body 27. That is, this configuration can prevent the damage and the breakage of the current collectors caused at the time when they are integrated. Therefore, according to the present invention, it is possible to provide a battery 20 in which the electrical resistance can be reduced.

In the present invention, the cathode current collector 21 may be constituted by the same material as that of the cathode current collector 4; and the thickness of the cathode current collector 21 may be for example several micrometers to several ten micrometers. In addition, the anode current collector 22 may be constituted by the same material as that of the anode current collector 5; and the thickness of the anode current collector 22 may be for example several micrometers to several ten micrometers.

Further, in the present invention, the conductor 24 may be constituted by a known conductive material that can endure the environment under which the battery 20 is used and can join the cathode current collector 21 and the anode current collector 22. In the case of using an aluminum foil as the cathode current collector 21 and using a copper foil as the anode current collector 22, for example a clad material formed by metallurgically combining aluminum and copper may be used as the conductor 24.

Also in the present invention, the configuration of the connection portion 25 is not particularly limited as long as the cathode current collector 21 and the anode current collector 22 are connected, via the conductor 24, in the entire longitudinal direction thereof. The connection portion 25 may be configured for example in a way that at least a part in the longitudinal direction of one end of the cathode current collector 21 in its shorter direction is welded to the conductor 24, and at least a part in the longitudinal direction of one end of the anode current collector 22 in its shorter direction is welded to the conductor 24.

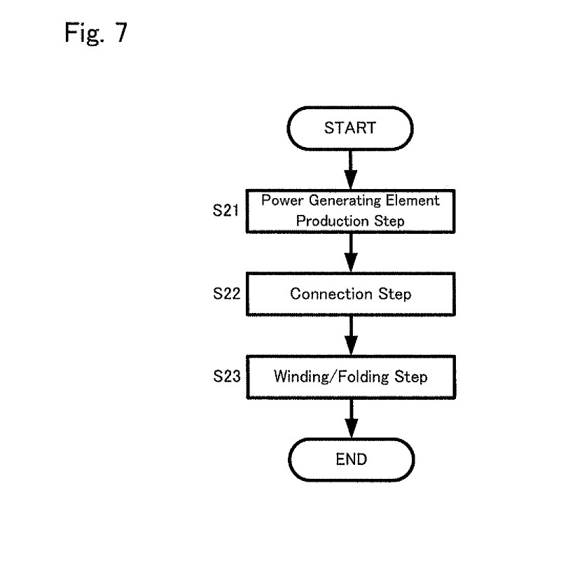

FIG. 7 is a flow chart illustrating a manufacturing process of the battery 20. Hereinafter, a manufacturing method of the battery 20 (one configuration of a manufacturing method of a battery according to the present invention) will be described with reference to FIGS. 5 to 7. As shown in FIG. 7, the battery 20 is manufactured through a power generating element production step (S21), a connection step (S22), and a winding/folding step (S23).

The power generating element production step (hereinafter referred to as “S21”) is a step of producing the power generating elements 23, 23, . . . . In the manufacturing method of the battery 20, the configuration of S21 is not particularly limited as long as S21 can produce the power generating elements 23, 23, . . . . In S21, for example the cathode layer 1, 1 having a thickness of 50 μm is disposed on each of the front and back faces of the cathode current collector 21 by the same method as in S11; and thereby a cathode structure can be produced. Further, for example the anode layer 2, 2 having a thickness of 60 μm is disposed on each of the front and back faces of the anode current collector 22 by the same method as in S11; and thereby an anode structure can be produced. Furthermore, for example the electrolyte layer 3 having a thickness of 20 μm can be produced by the same method as in S11. After making the cathode structure, the anode structure, and the electrolyte layer 3 in this manner, the cathode structure, the electrolyte layer 3, and the anode structure are layered such that the electrolyte layer 3 is disposed between a pair of the cathode layer 1 and the anode layer 2. Thereby, the power generating element 23 can be produced. By repeating the above process, a plurality of power generating elements 23, 23, . . . can be produced.

The connection step (hereinafter referred to as “S22”) is a step of connecting, by using the conductor 24, the cathode current collector 21 included in the power generating element 23 produced in S21 above with the anode current collector 22 included in the power generating element 23 adjacent thereto in the left and right direction of the drawing sheet of FIG. 5; thereby forming the connection portion 25; and through this process, making the structure 26 shown in FIG. 5. The configuration of S22 is not particularly limited as long as S22 can produce the structure 26 comprising a plurality of the connection portions 25, 25, . . . . For example, in S22, at least a part in the longitudinal direction of one end of the cathode current collector 21 in its shorter direction is welded to the conductor 24, and at least a part in the longitudinal direction of one end of the anode current collector 22 in its shorter direction is welded to the conductor 24. Thereby, the connection portion 25 can be formed.

The winding/folding step (hereinafter referred to as “S23”) is a step of winding the structure 26 produced in S22 above in the longitudinal direction of the cathode current collector 21 and the anode current collector 22, and thereby producing the wound body 27.

Through the steps S21 to S23 as above, the wound body 27 can be produced. Then, the battery 20 can be manufactured through the process of for example accommodating the wound body 27 into an exterior material and sealing the exterior material in which the wound body 27 is accommodated. Therefore, according to the present invention, it is possible to provide a manufacturing method of a battery which enables manufacturing of the battery 20 in which the electrical resistance between the power generating elements 23, 23 can be reduced.

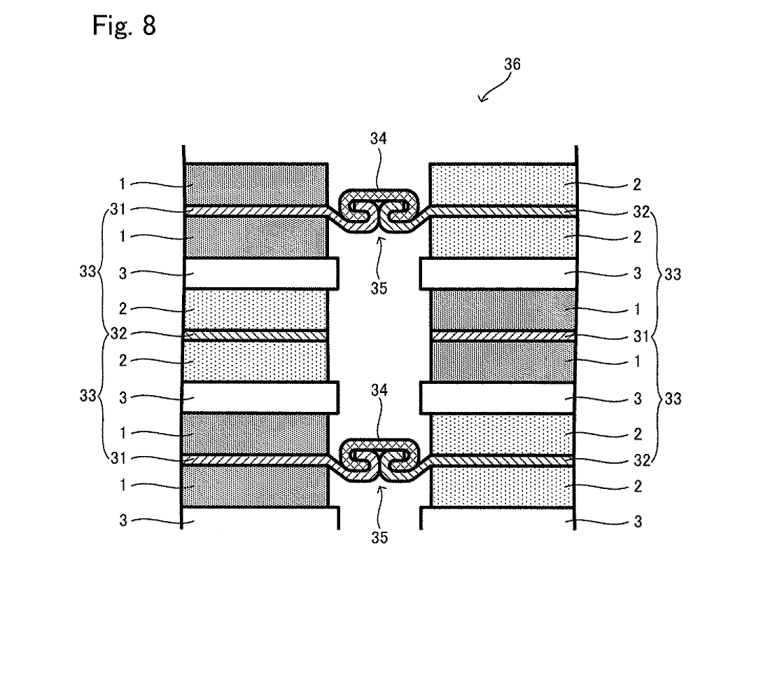

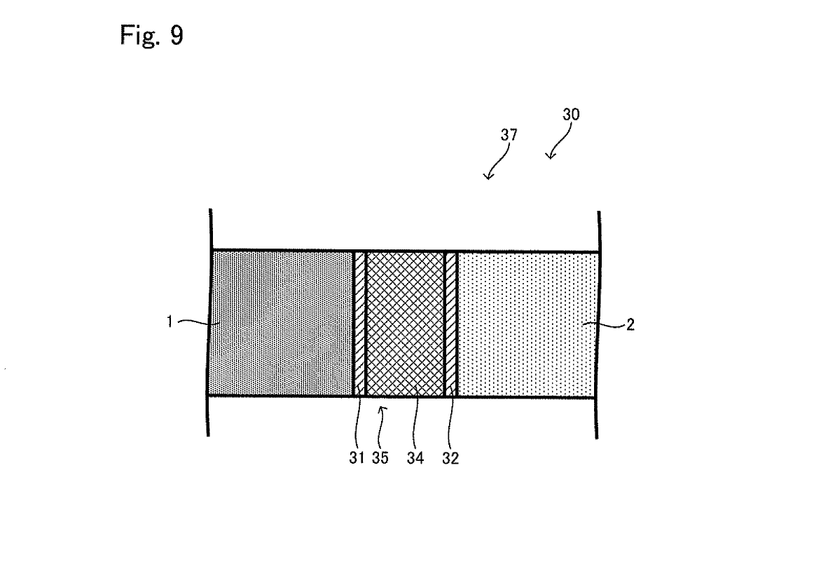

FIGS. 8 and 9 are views illustrating a battery 30 of the present invention according to a third embodiment. FIG. 8 corresponds to FIG. 5. FIG. 8 shows a cross section of a structure 36 comprising power generating elements 33, 33, . . . before wound. It only shows the connection parts of two sets of cathode current collector 31, 31 and anode current collector 32, 32, and the surrounding area thereof. The left and right direction of the drawing sheet of FIG. 8 is the shorter direction of the cathode current collector 31 and the anode current collector 32. The back and front direction of the drawing sheet of FIG. 8 is the longitudinal direction of the cathode current collector 31 and the anode current collector 32. In addition, FIG. 9 is a front view illustrating a wound body 37 formed after winding the power generating elements 33, 33, . . . . It shows only a connection portion 35 and the surrounding area thereof. The left and right direction of the drawing sheet of FIG. 9 is the shorter direction of the cathode current collector 31, the anode current collector 32, and the conductor 34. In FIGS. 8 and 9, the same constituents as those of the battery 20 are given the same reference numerals given in FIGS. 5 and 6; and descriptions thereof will be omitted.

As shown in FIGS. 8 and 9, the structure 36 and the wound body 37 comprise a plurality of power generating elements 33, 33, . . . each provided with: a cathode layer 1; an anode layer 2; an electrolyte layer 3 disposed between the cathode layer 1 and the anode layer 2; a cathode current collector 31 connected to the cathode layer 1; and an anode current collector 32 connected to the anode layer 2. The cathode layer 1, 1 is disposed on front and back faces of the cathode current collector 31. The anode layer 2, 2 is disposed on front and back faces of the anode current collector 32. The electrolyte layer 3 is disposed between a pair of the cathode layer 1 and the anode layer 2. In the structure 36, one end of the cathode current collectors 31, 31, . . . and of the anode current collectors 32, 32, . . . in the shorter direction thereof is bent over its entire length; and both ends of the conductor 34 in the shorter direction thereof are bent over their entire length. The bent side of the cathode current collector 31 and one end side of the conductor 34 in the shorter direction thereof are fitted with each other; and the bend side of the anode current collector 32 and the other end side of the conductor 34 in the shorter direction thereof are fitted with each other. Thereby, the connection portion 35 is formed. The structure 36 comprising a plurality of the connection the portions 35, 35, . . . is wound in the back and front direction of the drawing sheet of FIG. 8, and thereby is formed into the wound body 37. Then, the battery 30 of the present invention is produced for example by accommodating this wound body 37 into an exterior material.

In the battery 30, the cathode current collector 31 and the anode current collector 32 have been integrated via the conductor 34 in the stage of the structure 36. Therefore, it is unnecessary to integrate the cathode current collectors 31, 31, . . . and the anode current collectors 32, 32, after forming the wound body 37. That is, with this configuration as well, the damage and the breakage of the current collectors caused at a time of integrating them can be prevented. Therefore, according to the present invention, it is possible to provide a battery 30 in which the electrical resistance can be reduced.

In the present invention, the cathode current collector 31 may be constituted by the same material as that of the cathode current collector 4; and the thickness of the cathode current collector 31 may be for example several micrometers to several ten micrometers. In addition, the anode current collector 32 may be constituted by the same material as that of the anode current collector 5; and the thickness of the anode current collector 32 may be for example several micrometers to several ten micrometers.

Further, in the present invention, the conductor 34 may be constituted by the same material as that of the conductor 24. In the case of using an aluminum foil as the cathode current collector 31 and using a copper foil as the anode current collector 32, for example a clad material formed by metallurgically combining aluminum and copper may be used as the conductor 34.

Also in the present invention, the configuration of the connection portion 35 is not particularly limited as long as the cathode current collector 31 and the anode current collector 32 are connected, via the conductor 34, in the entire longitudinal direction thereof. The connection portion 35 may be configured for example in such a manner as welding at least the parts of the cathode current collector 31 and the conductor 34 in the longitudinal direction that are fitted with each other, and welding at least the parts of the anode current collector 32 and the conductor 34 in the longitudinal direction that are fitted with each other.

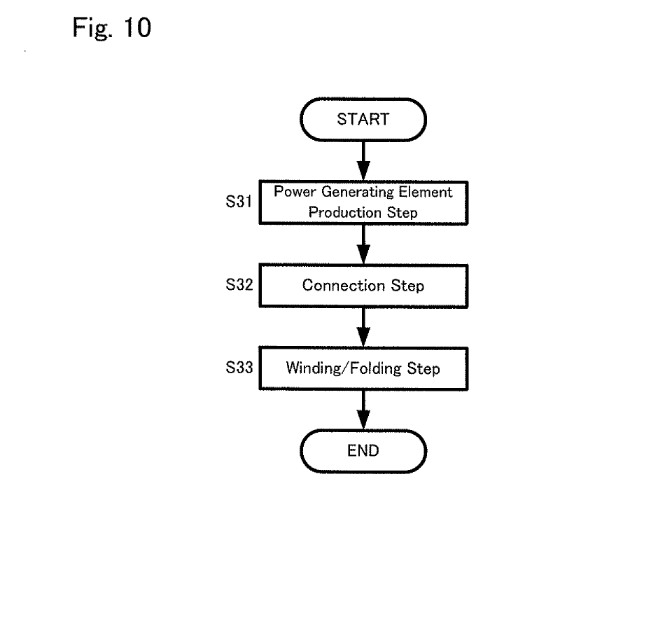

FIG. 10 is a flow chart illustrating a manufacturing process of the battery 30. Hereinafter, a manufacturing method of the battery 30 (one configuration of a manufacturing method of a battery according to the present invention) will be described with reference to FIGS. 8 to 10. As shown in FIG. 10, the battery 30 is manufactured through a power generating element production step (S31), a connection step (S32), and a winding/folding step (S33).

The power generating element production step (hereinafter referred to as “S31”) is a step of producing the power generating elements 33, 33, . . . . In the manufacturing method of the battery 30, the configuration of S31 is not particularly limited as long as S31 can produce the power generating elements 33, 33, . . . . In S31, for example the cathode layer 1, 1 having a thickness of 50 μm is disposed on each of the front and back faces of the cathode current collector 31 by the same method as in S11; and thereby a cathode structure can be produced. Further, for example the anode layer 2, 2 having a thickness of 60 μm is disposed on each of the front and back faces of the anode current collector 32 by the same method as in S11; and thereby an anode structure can be produced. Furthermore, for example the electrolyte layer 3 having a thickness of 20 μm can be produced by the same method as in S11. After making the cathode structure, the anode structure, and the electrolyte layer 3 in this manner, the cathode structure, the electrolyte layer 3, and the anode structure are layered such that the electrolyte layer 3 is disposed between a pair of the cathode layer 1 and the anode layer 2. Thereby, the power generating element 33 can be produced. By repeating the above process, a plurality of power generating elements 33, 33, . . . can be produced.

The connection step (hereinafter referred to as “S32”) is a step of connecting, by using the conductor 34, the cathode current collector 31 included in the power generating element 33 produced in S31 above with the anode current collector 32 included in the power generating element 33 adjacent thereto in the left and right direction of the drawing sheet of FIG. 8; thereby forming the connection portion 35; and through this process, making the structure 36 shown in FIG. 8. The configuration of S32 is not particularly limited as long as S32 can produce the structure 36 comprising a plurality of the connection portions 35, 35, . . . . For example, in S32, the bent side of the cathode current collector 31 and one end side of the conductor 34 in the shorter direction thereof are fitted with each other; and thereafter they are welded. Also the bend side of the anode current collector 32 and the other end side of the conductor 34 in the shorter direction thereof are fitted with each other; and thereafter they are welded. Thereby, the connection portion 35 can be formed.

The winding/folding step (hereinafter referred to as “S33”) is a step of winding the structure 36 produced in S32 above in the longitudinal direction of the cathode current collector 31 and the anode current collector 32, and thereby producing the wound body 37.

Through the steps S31 to S33 as above, the wound body 37 can be produced. Then, the battery 30 can be manufactured through the process of for example accommodating the wound body 37 into an exterior material and sealing the exterior material in which the wound body 37 is accommodated. Therefore, according to the present invention, it is possible to provide a manufacturing method of a battery which enables manufacturing of the battery 30 in which the electrical resistance between the power generating elements 33, 33 can be reduced.

In the above descriptions of the present invention, the configuration has been shown in which the plurality of power generating elements are wound. However, the present invention is not limited to this configuration. The battery of the present invention may comprise a plurality of folded power generating cells. Also, the manufacturing method of a battery of the present invention may comprise a winding/folding step in which a plurality of power generating cells are folded.

Further, in the above descriptions of the present invention, the configuration has been shown as an example in which a cathode material and an anode material capable of storing and releasing lithium ions are provided. However, the present invention is not limited to this configuration. For example, with a configuration that a cathode material and an anode material capable of storing and releasing sodium ions or magnesium ions are provided, the present invention can be a battery in which the sodium ions or magnesium ions move, and a manufacturing method of such a battery.

### EXAMPLES

The distance was 15 mm from one end of a cathode current collector in the shorter direction thereof which is connected with an anode current collector to an end face of a cathode layer formed on front and back faces of this cathode current collector. Likewise, the distance was 15 mm from one end of an anode current collector in the shorter direction thereof which is connected with the cathode current collector to an end face of an anode layer formed on front and back faces of this anode current collector. Then a plurality of power generating elements constituted by disposing an electrolyte layer between the cathode layer and the anode layer were layered to have a thickness of 10 mm. Through this process, a wound body 9, structures 26 and 36, and a structure 95 were made. Then, it was examined whether or not the current collectors (the cathode current collector and the anode current collector) were damaged and broken; and the electrical resistance between the cathode current collector and the anode current collector connected to each other (between the power generating elements) was measured.

According to the results, in the wound body 9, and the structures 26, 36, occurrence of the damage and the breakage of the cathode current collector and the anode current collector was not confirmed. By contrast, in the structure 95, the followings were broken (partially broken): the cathode current collector which was disposed farthest from the location where a plurality of current collectors were collected together; and the current collector which was disposed next to this cathode current collector.

In addition, the electrical resistance between the power generating elements in the wound body 9 was 0.8 mΩ. The electrical resistance between the power generating elements in the structure 26 was 1.1 mΩ. The electrical resistance between the power generating elements in the structure 36 was 0.9 mΩ. By contrast, the electrical resistance between the power generating elements in the structure 95 was 1.5 mΩ.

As above, according to the present invention, it was possible to inhibit the breakage of the current collectors, and to reduce the electrical resistance between the power generating elements.

### INDUSTRIAL APPLICABILITY

The battery of the present invention can be used as a power source for electric vehicles, portable information appliances, and so on. The manufacturing method of a battery of the present invention can be used in manufacturing such a battery as above.

1. A battery comprising a plurality of power generating elements each comprising: a cathode layer; an anode layer; an electrolyte layer disposed between the cathode layer and the anode layer; a cathode current collector connected to the cathode layer; and an anode current collector connected to the anode layer,
wherein the plurality of power generating elements are wound or folded; and
the cathode current collector included in one of the power generating elements and the anode current collector included in another power generating element adjacent to that power generating element are formed separately, and are directly or indirectly connected to each other in the entire longitudinal direction of the cathode current collector and the anode current collector before and after the power generating elements are wound or folded.

2. The battery according to claim 1, wherein the cathode current collector which is bent and the anode current collector which is bent are fitted with each other, and thereby the cathode current collector and the anode current collector are connected to each other.

3. The battery according to claim 2, wherein the cathode current collector and the anode current collector that are connected to each other are fixated by a fixating member.

4. The battery according to claim 1, wherein the cathode current collector and the anode current collector are connected via a conductor which is in contact with the cathode current collector and the anode current collector.

5. The battery according to claim 4, wherein the cathode current collector which is bent and the conductor which is bent are fitted with each other, and the conductor which is bent and the anode current collector which is bent are fitted with each other.

6. A manufacturing method of a battery comprising:
a power generating element production step of producing a plurality of power generating elements each comprising a cathode layer, an anode layer, an electrolyte layer disposed between the cathode layer and the anode layer, a cathode current collector connected to the cathode layer, and an anode current collector connected to the anode layer;
a connection step of connecting directly or indirectly the cathode current collector included in one of the power generating elements produced in the power generating element production step and the anode current collector included in another power generating element produced in the power generating element production step, in the entire longitudinal direction of the cathode current collector and the anode current collector; and
a winding/folding step of winding or folding the plurality of power generating elements after the connection step.

7. The manufacturing method of a battery according to claim 6, wherein the connection step is a step of fitting the cathode current collector which is bent with the anode current collector which is bent, and thereby connecting the cathode current collector and the anode current collector to each other.

8. The manufacturing method of a battery according to claim 7, further comprising, after the winding/folding step, a fixation step of fixating the cathode current collector and the anode current collector connected to each other by using a fixating member.

9. The manufacturing method of a battery according to claim 6, wherein the connection step is a step of connecting the cathode current collector and the anode current collector via a conductor which is in contact with the cathode current collector and the anode current collector.

10. The manufacturing method of a battery according to claim 9, wherein the connection step is a step of fitting the cathode current collector which is bent with the conductor which is bent, also fitting the conductor which is bent with the anode current collector which is bent, and thereby connecting the cathode current collector and the anode current collector.

11. The battery according to claim 2, wherein the cathode current collector and the anode current collector are connected via a conductor which is in contact with the cathode current collector and the anode current collector.

12. The battery according to claim 3, wherein the cathode current collector and the anode current collector are connected via a conductor which is in contact with the cathode current collector and the anode current collector.

13. The manufacturing method of a battery according to claim 7, wherein the connection step is a step of connecting the cathode current collector and the anode current collector via a conductor which is in contact with the cathode current collector and the anode current collector.

14. The manufacturing method of a battery according to claim 8, wherein the connection step is a step of connecting the cathode current collector and the anode current collector via a conductor which is in contact with the cathode current collector and the anode current collector.
